(19) United States
(12) Patent Application Publication
(10) Pub. No.: US 2005/0271974 A1
(43) Pub. Date: Dec. 8, 2005

(54) Photoactive compounds

(76) Inventors: M. Dalil Rahman, Flemington, NJ (US); Woo-Kyu Kim, Bedminster, NJ (US); Munirathna Padmanaban, Bridgewater, NJ (US); Sangho Lee, Bridgewater, NJ (US)

Correspondence Address: Clariant Corporation, 70 Meister Avenue, Somerville, NJ, 08876, US

(21) Appl. No.: 10/863,042

(22) Filed: Jun. 8, 2004

(51) Int. Cl. G03C 1/492

(52) U.S. Cl. 430/270.1

(57) ABSTRACT

The present invention relates to novel photoacid generators.

### FIELD OF INVENTION

The present invention relates to a novel photoactive compounds useful in photoresist compositions in the field of microlithography, and especially useful for imaging negative and positive patterns in the production of semiconductor devices, as well as photoresist compositions and processes for imaging photo resists.

### BACKGROUND OF THE INVENTION

Photoresist compositions are used in microlithography processes for making miniaturized electronic components such as in the fabrication of computer chips and integrated circuits. Generally, in these processes, a thin coating of film of a photoresist composition is first applied to a substrate material, such as silicon wafers used for making integrated circuits. The coated substrate is then baked to evaporate any solvent in the photoresist composition and to fix the coating onto the substrate. The photoresist coated on the substrate is next subjected to an image-wise exposure to radiation.

The radiation exposure causes a chemical transformation in the exposed areas of the coated surface. Visible light, ultraviolet (UV) light, electron beam and X-ray radiant energy are radiation types commonly used today in microlithographic processes. After this image-wise exposure, the coated substrate is treated with a developer solution to dissolve and remove either the radiation exposed or the unexposed areas of the photoresist. The trend toward the miniaturization of semiconductor devices has led to the use of new photoresists that are sensitive at lower and lower wavelengths of radiation and has also led to the use of sophisticated multilevel systems to overcome difficulties associated with such miniaturization.

There are two types of photoresist compositions: negative-working and positive-working. The type of photoresist used at a particular point in lithographic processing is determined by the design of the semiconductor device. When negative-working photoresist compositions are exposed image-wise to radiation, the areas of the photoresist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating, thereby uncovering a desired portion of the underlying substrate surface on which the photoresist composition was deposited.

On the other hand, when positive-working photoresist compositions are exposed image-wise to radiation, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying surface is uncovered.

Photoresist resolution is defined as the smallest feature, which the resist composition can transfer from the photomask to the substrate with a high degree of image edge acuity after exposure and development. In many leading edge manufacturing applications today, photoresist resolution on the order of less than one-half micron are necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices. In cases where the photoresist dimensions have been reduced to below 150 nm, the roughness of the photoresist patterns has become a critical issue. Edge roughness, commonly known as line edge roughness, is typically observed for line and space patterns as roughness along the photoresist line, and for contact holes as side wall roughness. Edge roughness can have adverse effects on the lithographic performance of the photoresist, especially in reducing the critical dimension latitude and also in transferring the line edge roughness of the photoresist to the substrate. Hence, photoresists that minimize edge roughness are highly desirable.

Photoresists sensitive to short wavelengths, between about 100 nm and about 300 nm are often used where subhalfmicron geometries are required. Particularly preferred are photoresists comprising non-aromatic polymers, a photoacid generator, optionally a dissolution inhibitor, and solvent.

High resolution, chemically amplified, deep ultraviolet (100-300 nm) positive and negative tone photoresists are available for patterning images with less than quarter micron geometries. To date, there are three major deep ultraviolet (UV) exposure technologies that have provided significant advancement in miniaturization, and these use lasers that emit radiation at 248 nm, 193 nm and 157 nm. Photoresists used in the deep UV typically comprise a polymer which has an acid labile group and which can deprotect in the presence of an acid, a photoactive component which generates an acid upon absorption of light, and a solvent.

Photoresists for 248 nm have typically been based on substituted polyhydroxystyrene and its copolymers, such as those described in U.S. Pat. No. 4,491,628 and U.S. Pat. No. 5,350,660. On the other hand, photoresists for 193 nm exposure require non-aromatic polymers, since aromatics are opaque at this wavelength. U.S. Pat. No. 5,843,624 and GB 2,320,718 disclose photoresists useful for 193 nm exposure. Generally, polymers containing alicyclic hydrocarbons are used for photoresists for exposure below 200 nm. Alicyclic hydrocarbons are incorporated into the polymer for many reasons, primarily since they have relatively high carbon:hydrogen ratios which improve etch resistance, they also provide transparency at low wavelengths and they have relatively high glass transition temperatures. Photoresists sensitive at 157 nm have been based on fluorinated polymers, which are known to be substantially transparent at that wavelength. Photoresists derived from polymers containing fluorinated groups are described in WO 00/67072 and WO 00/17712.

The polymers used in a photoresist are designed to be transparent to the imaging wavelength, but on the other hand, the photoactive component has been typically designed to be absorbing at the imaging wavelength to maximize photosensitivity. The photosensitivity of the photoresist is dependent on the absorption characteristics of the photoactive component, the higher the absorption, the less the energy required to generate the acid, and the more photosensitive is the photoresist.

Recent publications describe photoacid generators (US 2002/0197558 A1 and U.S. 2003/0113659 A1).

### SUMMARY OF THE INVENTION

The present invention relates to a compound of the formula 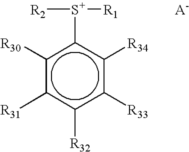
wherein R₁ and R₂ are each independently selected from C₁₋₂₀ straight or branched alkyl chain; each of R₃₀, R₃₁, R₃₂, R₃₃, and R₃₄ are independently selected from Z, hydrogen, C₁₋₂₀ straight or branched alkyl chain optionally containing one or more O atoms, C₅₋₅₀ monocyclic or polycyclic alkyl group, C₅₋₅₀ cyclic alkylcarbonyl group, C₆₋₅₀ aryl group, C₆₋₅₀ aralkyl group, arylcarbonylmethylene group, —OR₄ where R₄ is hydrogen, C₁₋₂₀ straight or branched alkyl group or C₅₋₅₀ monocyclic or polycyclic alkyl group; Z is —(O)ₖ—(V)ₙ—Y, where V is a linkage group selected from a divalent C₁₋₂₀ straight or branched alkyl group, divalent C₅₋₅₀ aryl group, divalent C₅₋₅₀ aralkyl group, or divalent C₅₋₅₀ monocyclic or polycyclic alkyl group; Y is selected from —C(═)—O—R₈ and —O—C(═O)—R₈; R₈ is a C₁₋₂₀ straight or branched alkyl chain optionally containing one or more O atoms, a C₅₋₅₀ monocyclic or polycyclic alkyl group, or a C₅₋₅₀ aryl group; k is 0 or 1, and n is 0 or 1; the C₁₋₂₀ straight or branched alkyl chain optionally containing one or more O atoms, C₁₋₂₀ straight or branched alkyl chain, C₅₋₅₀ monocyclic or polycyclic alkyl group, C₅₋₅₀ cyclic alkylcarbonyl group, C₅₋₅₀ aralkyl group, C₅₋₅₀ aryl group, or arylcarbonylmethylene group being unsubstituted or substituted by one or more groups selected from the group consisting of Z, halogen, C₁₋₂₀ alkyl, C₁₋₂₀ perfluoroalkyl C₃₋₂₀ cyclic alkyl, C₁₋₂₀ alkoxy, C₃₋₂₀ cyclic alkoxy, di C₁₋₂₀ alkylamino, dicyclic di C₁₋₂₀ alkylamino, hydroxyl, cyano, nitro, tresyl, oxo, aryl, aralkyl, oxygen atom, CF₃SO₃, aryloxy, arylthio, and groups of formulae (II) to (VI): 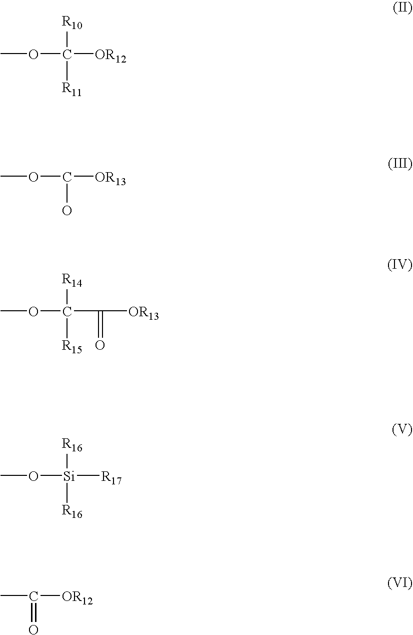
R₁₀ and R₁₁ each independently represent a hydrogen atom, a C₁₋₂₀ straight or branched alkyl chain optionally containing one or more O atoms, or a C₅₋₅₀ monocyclic or polycyclic alkyl group, or R₁₀ and R₁₁ together can represent an alkylene group to form a five- or six-membered ring,
R₁₂ represents a C₁₋₂₀ straight or branched alkyl chain optionally containing one or more O atoms, a C₅₋₅₀ monocyclic or polycyclic alkyl group, or a C₅₋₅₀ aralkyl group, or R₁₀ and R₁₂ together represent an alkylene group which forms a five- or six-membered ring together with the interposing —C—O— group, the carbon atom in the ring being optionally substituted by an oxygen atom,
R₁₃ represents a C₁₋₂₀ straight or branched alkyl chain optionally containing one or more O atoms or a C₅₋₅₀ monocyclic or polycyclic alkyl group,
R₁₄ and R₁₅ each independently represent a hydrogen atom, a C₁₋₂₀ straight or branched alkyl chain optionally containing one or more O atoms or a C₅₋₅₀ monocyclic or polycyclic alkyl group,
R₁₆ represents a C₁₋₂₀ straight or branched alkyl chain optionally containing one or more O atoms, a C₅₋₅₀ monocyclic or polycyclic alkyl group, a C₅₋₅₀ aryl group, or a C₅₋₅₀ aralkyl group, and R₁₇ represents C₁₋₂₀ straight or branched alkyl chain optionally containing one or more O atoms, a C₅₋₅₀ monocyclic or polycyclic alkyl group, a C₅₋₅₀ aryl group, a C₅₋₅₀ aralkyl group, the group —Si(R₁₆)₂R₁₇, or the group —O—Si(R₁₆)₂R₁₇, the C₁₋₂₀ straight or branched alkyl chain optionally containing one or more O atoms, C₅₋₅₀ monocyclic, bicyclic, or tricyclic alkyl group, C₅₋₅₀ aryl group, and C₅₋₅₀ aralkyl group being unsubstituted or substituted as above; and A⁻ is an anion represented by the formula
   Rg-O-Rf-SO₃⁻
   where Rf is selected from the group consisting of linear or branched (CF₂)ⱼ where j is an integer from 4 to 10 and C₃-C₁₂ perfluorocycloalkyl divalent radical which is optionally perfluoroC₁₋₁₀alkyl substituted,
Rg is selected from the group consisting of C₁-C₂₀ linear, branched, monocyclic or polycyclic alkyl, C₁-C₂₀ linear, branched, monocyclic or polycyclic alkenyl, C₅₋₅₀ aryl, and C₅₋₅₀ aralkyl, the alkyl, alkenyl, aralkyl and aryl groups being unsubstituted, substituted, partially fluorinated or perfluorinated.

Examples of the above compounds include 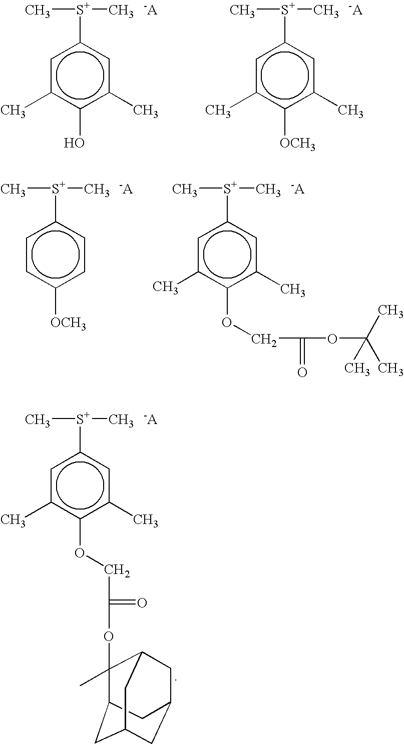
Examples of ⁻A include CF₃CHFO(CF₂)₄SO₃⁻, CF₃CH₂O(CF₂)₄SO₃⁻, CH₃CH₂O(CF₂)₄SO₃—, and CH₃CH₂CH₂O(CF₂)₄SO₃⁻.

The present invention also relates to a photoresist composition comprising a polymer containing an acid labile group and a compound as described above. In addition, the present invention also relates to a process for imaging a photoresist comprising coating the aforementioned photoresist composition on a substrate, baking the substrate to substantially remove the solvent; image-wise exposing the photoresist coating; post-exposure baking the photoresist coating; and developing the photoresist coating with an aqueous alkaline solution.

In the photoresist composition, the polymer can be comprised of one or more monomers selected from maleic anhydride, t-butyl norbornene carboxylate, mevalonic lactone methacrylate, 2-methyl-2-adamantyl methacrylate, 2-methyl-2-adamantyl acrylate, 2-ethyl-2-adamantyl methacrylate, 3,5-dimethyl-7-hydroxy adamantyl methacrylate, 3-hydroxy-1-methacryloxyadamantane, 3-hydroxy-1-adamantyl acrylate, ethycyclopentylacrylate, tricyclo[5,2,1,0^{2,6}]deca-8-yl methacrylate, 3,5-dihydroxy-1-methacryloxyadamantane, gamma-butyrolactone methacrylate, methacryloylxy norbornane methacrylate, and mixtures thereof.

In the photoresist composition, the polymer can be selected from the group poly(2-methyl-2-adamantyl methacrylate-co-2-ethyl-2-adamantyl methacrylate-co-3-hydroxy-1-methacryloxyadamantane-co-α-gamma-butyrolactone methacrylate); poly(2-ethyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-β-gamma-butyrolactone methacrylate); poly(t-butyl norbornene carboxylate-co-maleic anhydride-co-2-methyl-2-adamantyl methacrylate-co-β-gamma-butyrolactone methacrylate-co-methacryloyloxy norbornane methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-β-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); poly(2-methyl-2-adamantyl methacrylate-co-3,5-dihydroxy-1-methacryloxyadamantane-co-α-gamma-butyrolactone methacrylate); poly(2-methyl-2-adamantyl methacrylate-co-3,5-dimethyl-7-hydroxy adamantyl methacrylate-co-α-gamma-butyrolactone methacrylate); poly(2-methyl-2-adamantyl acrylate-co-3-hydroxy-1-methacryloxyadamantane-co-α-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-β-gamma-butyrolactone methacrylate-co-3-hydroxy-1-methacryloxyadamantane-co-ethylcyclopentylacrylate); poly(2-methyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-methacryloxyadamantane-co-α-gamma-butyrolactone methacrylate-co-2-ethyl-2-adamantyl methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-2-ethyl-2-adamantyl methacrylate-co-β-gamma-butyrolactone methacrylate-co-3-hydroxy-1-methacryloxyadamantane); and poly(2-methyl-2-adamantyl methacrylate-co-2-ethyl-2-adamantyl methacrylate-co-α-gamma-butyrolactone methacrylate-co-3-hydroxy-1-methacryloxyadamantane).

The invention further provides a method for producing a semiconductor device by producing a photo-image on a substrate by coating a suitable substrate with a photoresist composition. The subject process comprises coating a suitable substrate with a photoresist composition and heat treating the coated substrate until substantially all of the photoresist solvent is removed; image-wise exposing the composition and removing the image-wise exposed areas of such composition with a suitable developer.

### DETAILED DESCRIPTION OF THE INVENTION

The present invention relates to a compound of the formula 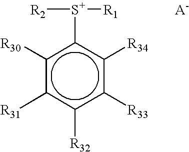
wherein R₁ and R₂ are each independently selected from C₁₋₂₀ straight or branched alkyl chain; each of R₃₀, R₃₁, R₃₂, R₃₃, and R₃₄ are independently selected from Z, hydrogen, C₁₋₂₀ straight or branched alkyl chain optionally containing one or more O atoms, C₅₋₅₀ monocyclic or polycyclic alkyl group, C₅₋₅₀ cyclic alkylcarbonyl group, C₆₋₅₀ aryl group, C₆₋₅₀ aralkyl group, arylcarbonylmethylene group, —OR₄ where R₄ is hydrogen, C₁₋₂₀ straight or branched alkyl group or C₅₋₅₀ monocyclic or polycyclic alkyl group; Z is —(O)ₖ—(V)ₙ—Y, where V is a linkage group selected from a divalent C₁₋₂₀ straight or branched alkyl group, divalent C₅₋₅₀ aryl group, divalent C₅₋₅₀ aralkyl group, or divalent C₅₋₅₀ monocyclic or polycyclic alkyl group; Y is selected from —C(═O)O—R₈ and —O—C(═O)—R₈; R₈ is a C₁₋₂₀ straight or branched alkyl chain optionally containing one or more O atoms, a C₅₋₅₀ monocyclic or polycyclic alkyl group, or a C₅₋₅₀ aryl group; k is 0 or 1, and n is 0 or 1; the C₁₋₂₀ straight or branched alkyl chain optionally containing one or more O atoms, C₁₋₂₀ straight or branched alkyl chain, C₅₋₅₀ monocyclic or polycyclic alkyl group, C₅₋₅₀ cyclic alkylcarbonyl group, C₅₋₅₀ aralkyl group, C₅₋₅₀ aryl group, or arylcarbonylmethylene group being unsubstituted or substituted by one or more groups selected from the group consisting of Z, halogen, C₁₋₂₀ alkyl, C₁₋₂₀ perfluoroalkyl C₃₋₂₀ cyclic alkyl, C₁₋₂₀ alkoxy, C₃₋₂₀ cyclic alkoxy, di C₁₋₂₀ alkylamino, dicyclic di C₁₋₂₀ alkylamino, hydroxyl, cyano, nitro, tresyl, oxo, aryl, aralkyl, oxygen atom, CF₃SO₃, aryloxy, arylthio, and groups of formulae (II) to (VI): 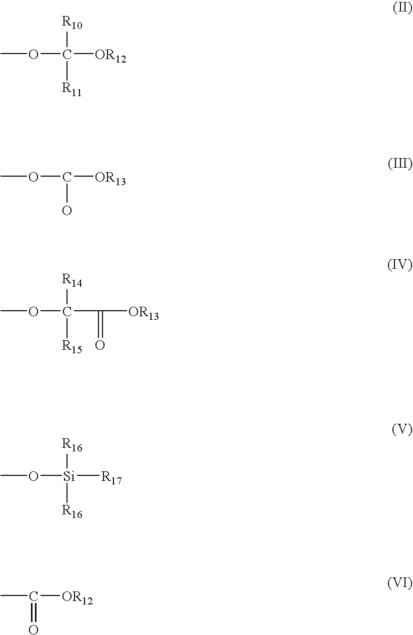
R₁₀ and R₁₁ each independently represent a hydrogen atom, a C₁₋₂₀ straight or branched alkyl chain optionally containing one or more O atoms, or a C₅₋₅₀ monocyclic or polycyclic alkyl group, or R₁₀ and R₁ together can represent an alkylene group to form a five- or six-membered ring,
R₁₂ represents a C₁₋₂₀ straight or branched alkyl chain optionally containing one or more O atoms, a C₅₋₅₀ monocyclic or polycyclic alkyl group, or a C₅₋₅₀ aralkyl group, or R₁₀ and R₁₂ together represent an alkylene group which forms a five- or six-membered ring together with the interposing —C—O— group, the carbon atom in the ring being optionally substituted by an oxygen atom,
R₁₃ represents a C₁₋₂₀ straight or branched alkyl chain optionally containing one or more O atoms or a C₅₋₅₀ monocyclic or polycyclic alkyl group,
R₁₄ and R₁₅ each independently represent a hydrogen atom, a C₁₋₂₀ straight or branched alkyl chain optionally containing one or more O atoms or a C₅₋₅₀ monocyclic or polycyclic alkyl group,
R₁₆ represents a C₁₋₂₀ straight or branched alkyl chain optionally containing one or more O atoms, a C₅₋₅₀ monocyclic or polycyclic alkyl group, a C₅₋₅₀ aryl group, or a C₅₋₅₀ aralkyl group, and
R₁₇ represents C₁₋₂₀ straight or branched alkyl chain optionally containing one or more O atoms, a C₅₋₅₀ monocyclic or polycyclic alkyl group, a C₅₋₅₀ aryl group, a C₅₋₅₀ aralkyl group, the group —Si(R₁₆)₂R₁₇, or the group —O—Si(R₁₆)₂R₁₇, the C₁₋₂₀ straight or branched alkyl chain optionally containing one or more O atoms, C₅₋₅₀ monocyclic, bicyclic, or tricyclic alkyl group, C₅₋₅₀ aryl group, and C₅₋₅₀ aralkyl group being unsubstituted or substituted as above; and
A⁻ is an anion represented by the formula
   Rg-O-Rf-SO₃⁻
   where Rf is selected from the group consisting of linear or branched (CF₂)ⱼ where j is an integer from 4 to 10 and C₃-C₁₂ perfluorocycloalkyl divalent radical which is optionally perfluoroC₁₋₁₀alkyl substituted,
Rg is selected from the group consisting of C₁-C₂₀ linear, branched, monocyclic or polycyclic alkyl, C₁-C₂₀ linear, branched, monocyclic or polycyclic alkenyl, C₅₋₅₀ aryl, and C₅₋₅₀ aralkyl, the alkyl, alkenyl, aralkyl and aryl groups being unsubstituted, substituted, partially fluorinated or perfluorinated.

Examples of the above compounds include 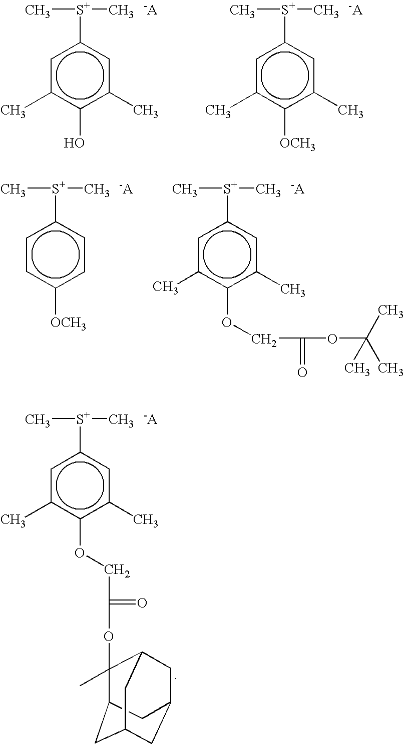
Examples of ⁻A include CF₃CHFO(CF₂)₄SO₃⁻, CF₃CH₂O(CF₂)₄SO₃⁻, CH₃CH₂O(CF₂)₄SO₃⁻, and CH₃CH₂CH₂O(CF₂)₄SO₃⁻.

The present invention also relates to a photoresist composition comprising a polymer containing an acid labile group and a compound as described above. In addition, the present invention also relates to a process for imaging a photoresist comprising coating the aforementioned photoresist composition on a substrate, baking the substrate to substantially remove the solvent; image-wise exposing the photoresist coating; post-exposure baking the photoresist coating; and developing the photoresist coating with an aqueous alkaline solution.

In the photoresist composition, the polymer can be comprised of one or more monomers selected from maleic anhydride, t-butyl norbornene carboxylate, mevalonic lactone methacrylate, 2-methyl-2-adamantyl methacrylate, 2-methyl-2-adamantyl acrylate, 2-ethyl-2-adamantyl methacrylate, 3,5-dimethyl-7-hydroxy adamantyl methacrylate, 3-hydroxy-1-methacryloxyadamantane, 3-hydroxy-1-adamantyl acrylate, ethycyclopentylacrylate, tricyclo[5,2,1,0^{2,6}]deca-8-yl methacrylate, 3,5-dihydroxy-1-methacryloxyadamantane, gamma-butyrolactone methacrylate, methacryloylxy norbornane methacrylate, and mixtures thereof.

In the photoresist composition, the polymer can be selected from the group poly(2-methyl-2-adamantyl methacrylate-co-2-ethyl-2-adamantyl methacrylate-co-3-hydroxy-1-methacryloxyadamantane-co-α-gamma-butyrolactone methacrylate); poly(2-ethyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-β-gamma-butyrolactone methacrylate); poly(t-butyl norbornene carboxylate-co-maleic anhydride-co-2-methyl-2-adamantyl methacrylate-co-β-gamma-butyrolactone methacrylate-co-methacryloyloxy norbornane methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-α-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); poly(2-methyl-2-adamantyl methacrylate-co-3,5-dihydroxy-1-methacryloxyadamantane-co-α-gamma-butyrolactone methacrylate); poly(2-methyl-2-adamantyl methacrylate-co-3,5-dimethyl-7-hydroxy adamantyl methacrylate-co-α-gamma-butyrolactone methacrylate); poly(2-methyl-2-adamantyl acrylate-co-3-hydroxy-1-methacryloxyadamantane-co-α-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-α-gamma-butyrolactone methacrylate-co-3-hydroxy-1-methacryloxyadamantane-co-ethylcyclopentylacrylate); poly(2-methyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-methacryloxyadamantane-co-α-gamma-butyrolactone methacrylate-co-2-ethyl-2-adamantyl methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-2-ethyl-2-adamantyl methacrylate-co-β-gamma-butyrolactone methacrylate-co-3-hydroxy-1-methacryloxyadamantane); and poly(2-methyl-2-adamantyl methacrylate-co-2-ethyl-2-adamantyl methacrylate-co-α-gamma-butyrolactone methacrylate-co-3-hydroxy-1-methacryloxyadamantane).

The invention further provides a method for producing a semiconductor device by producing a photo-image on a substrate by coating a suitable substrate with a photoresist composition. The subject process comprises coating a suitable substrate with a photoresist composition and heat treating the coated substrate until substantially all of the photoresist solvent is removed; image-wise exposing the composition and removing the image-wise exposed areas of such composition with a suitable developer.

By the term “aryl” is meant a radical derived from an aromatic hydrocarbon by the elimination of one atom of hydrogen and can be substituted or unsubstituted. The aromatic hydrocarbon can be mononuclear or polynuclear. Examples of aryl of the mononuclear type include phenyl, tolyl, xylyl, mesityl, cumenyl, and the like. Examples of aryl of the polynuclear type include naphthyl, anthryl, phenanthryl, and the like. The aryl group can be unsubstituted or substituted as provided for hereinabove.

By the term “aralkyl” is meant an alkyl group containing an aryl group. It is a hydrocarbon group having both aromatic and aliphatic structures, that is, a hydrocarbon group in which a lower alkyl hydrogen atom is substituted by a mononuclear or polynuclear aryl group.

Examples of C₅₋₅₀ monocyclic or polycyclic alkyl groups are well know to those skilled in the art and include, for example, cyclohexyl, 2-methyl-2-norbornyl, 2-ethyl-2-norbornyl, 2-methyl-2-isobornyl, 2-ethyl-2-isobornyl, 2-methyl-2-adamantyl, 2-ethyl-2-adamantyl, 1-adamantyl-1-methylethyl, and the like.

The moieties for R₁, R₂, and R₃₀ to R₃₄ may be unsubstituted or substituted. Examples of substitutes are shown above and in the claims.

Polymers useful in the photoresist compositions include those that have acid labile groups that make the polymer insoluble in aqueous alkaline solution, but such a polymer in the presence of an acid catalytically deprotects the polymer, wherein the polymer then becomes soluble in an aqueous alkaline solution. The polymers preferably are transparent below 200 nm, and are essentially non-aromatic, and preferably are acrylates and/or cycloolefin polymers. Such polymers are, for example, but not limited to, those described in U.S. Pat. No. 5,843,624, U.S. Pat. No. 5,879,857, WO 97/33,198, EP 789,278 and GB 2,332,679. Nonaromatic polymers that are preferred for irradiation below 200 nm are substituted acrylates, cycloolefins, substituted polyethylenes, etc. Aromatic polymers based on polyhydroxystyrene and its copolymers may also be used, especially for 248 nm exposure.

Polymers based on acrylates are generally based on poly(meth)acrylates with at least one unit containing pendant alicyclic groups, and with the acid labile group being pendant from the polymer backbone and/or from the alicyclic group. Examples of pendant alicyclic groups, may be adamantyl, tricyclodecyl, isobornyl, menthyl and their derivatives. Other pendant groups may also be incorporated into the polymer, such as mevalonic lactone, gamma butyrolactone, alkyloxyalkyl, etc. Examples of structures for the alicyclic group include:

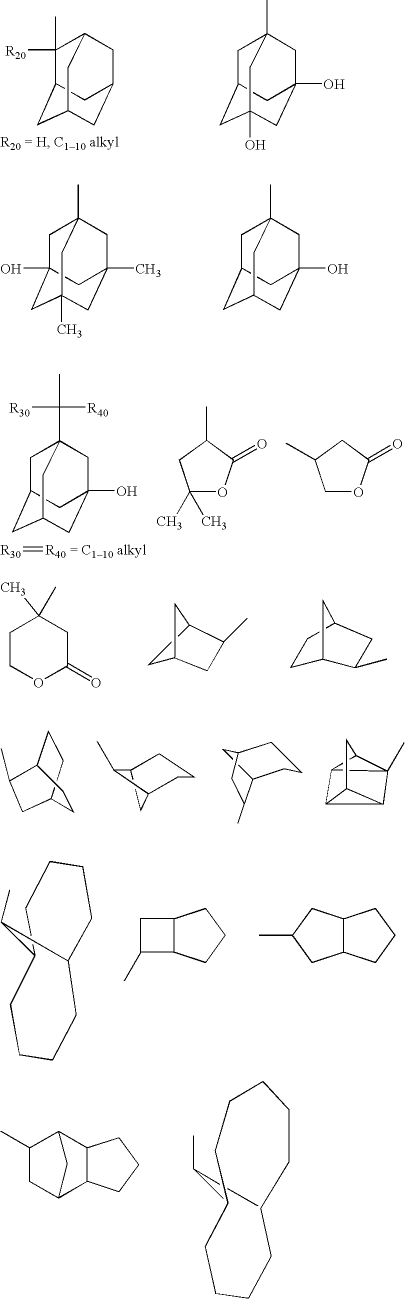

The type of monomers and their ratios incorporated into the polymer are optimized to give the best lithographic performance. Such polymers are described in R. R. Dammel et al., Advances in Resist Technology and Processing, SPIE, Vol. 3333, p144, (1998). Examples of these polymers include poly(2-methyl-2-adamantyl methacrylate-co-mevalonic lactone methacrylate), poly(carboxy-tetracyclododecyl methacrylate-co-tetrahydropyranylcarboxytetracyclododecyl methacrylate), poly(tricyclodecylacrylate-co-tetrahydropyranylmethacrylate-co-methacrylicacid), poly(3-oxocyclohexyl methacrylate-co-adamantylmethacrylate).

Polymers synthesized from cycloolefins, with norbornene and tetracyclododecene derivatives, may be polymerized by ring-opening metathesis, free-radical polymerization or using metal organic catalysts. Cycloolefin derivatives may also be copolymerized with cyclic anhydrides or with maleimide or its derivatives. Examples of cyclic anhydrides are maleic anhydride (MA) and itaconic anhydride. The cycloolefin is incorporated into the backbone of the polymer and may be any substituted or unsubstituted multicyclic hydrocarbon containing an unsaturated bond. The monomer can have acid labile groups attached. The polymer may be synthesized from one or more cycloolefin monomers having an unsaturated bond. The cycloolefin monomers may be substituted or unsubstituted norbornene, or tetracyclododecane. The substituents on the cycloolefin may be aliphatic or cycloaliphatic alkyls, esters, acids, hydroxyl, nitrile or alkyl derivatives. Examples of cycloolefin monomers, without limitation, include:

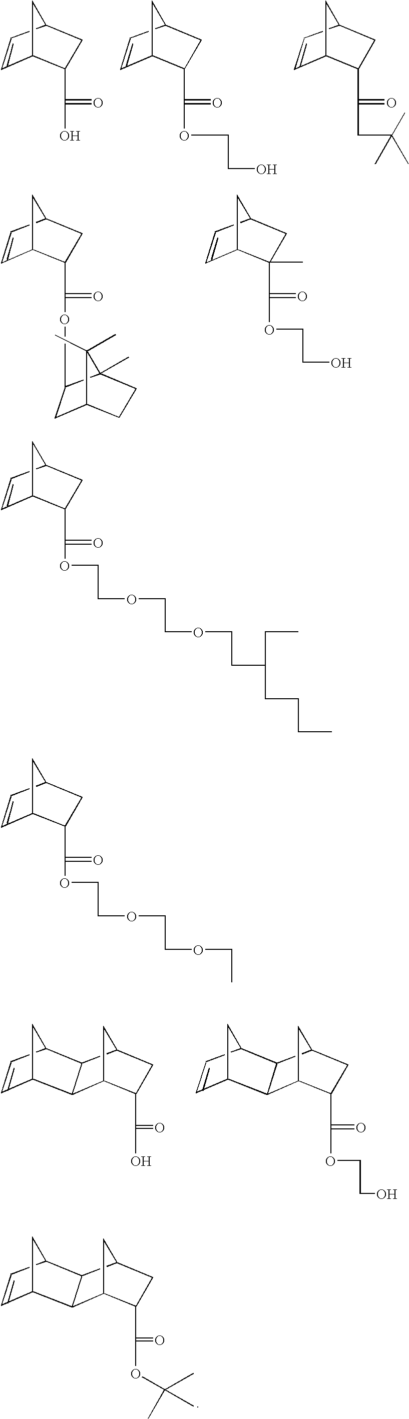

Other cycloolefin monomers which may also be used in synthesizing the polymer are:

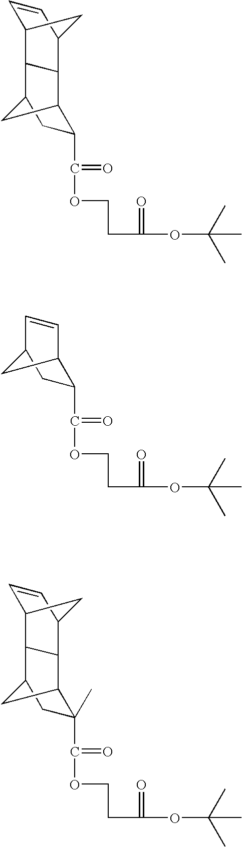

Such polymers are described in the following reference and incorporated herein, M-D. Rahman et al, Advances in Resist Technology and Processing, SPIE, Vol. 3678, p1193, (1999). Examples of these polymers include poly((t-butyl 5-norbornene-2-carboxylate-co-2-hydroxyethyl 5-norbornene-2-carboxylate-co-5-norbornene-2-carboxylic acid-co-maleic anhydride), poly(t-butyl 5-norbornene-2-carboxylate-co-isobornyl-5-norbornene-2-carboxylate-co-2-hydroxyethyl 5-norbornene-2-carboxylate-co-5-norbornene-2-carboxylic acid-co-maleic anhydride), poly(tetracyclododecene-5-carboxylate-co-maleic anhydride), poly(t-butyl 5-norbornene-2-carboxylate-co-maleic anhydride-co-2-methyladamantyl methacrylate-co-2-mevalonic lactone methacrylate), poly(2-methyladamantyl methacrylate-co-2-mevalonic lactone methacylate) and the like.

Polymers containing mixtures of (meth)acrylate monomers, cycloolefinic monomers and cyclic anhydrides, where such monomers are described above, may also be combined into a hybrid polymer. Examples of cycloolefin monomers include those selected from t-butyl norbornene carboxylate (BNC), hydroxyethyl norbornene carboxylate (HNC), norbornene carboxylic acid (NC), t-butyltetracyclo[4.4.0.1.^{2,6}1.^{7.10}] dodec-8-ene-3-carboxylate, and t-butoxy carbonylmethyl tetracyclo[4.4.0.1.^{2,6}1.^{7,10}] dodec-8-ene-3-carboxylate. In some instances, preferred examples of cycloolefins include t-butyl norbornene carboxylate (BNC), hydroxyethyl norbornene carboxylate (HNC), and norbornene carboxylic acid (NC). Examples of (meth)acrylate monomers include those selected from mevalonic lactone methacrylate (MLMA), 2-methyl-2-adamantyl methacrylate (MAdMA), 2-methyl-2-adamantyl acrylate (MAdA), 2-ethyl-2-adamantyl methacrylate (EAdMA), 3,5-dimethyl-7-hydroxy adamantyl methacrylate (DMHAdMA), isoadamantyl methacrylate, 3-hydroxy-1-methacryloxyadamatane (HAdMA), 3-hydroxy-1-adamantyl acrylate (HADA), ethylcyclopentylacrylate (ECPA), tricyclo[5,2,1,0^{2,6}]deca-8-yl methacrylate (TCDMA), 3,5-dihydroxy-1-methacryloxyadamantane (DHAdMA), β-methacryloxy-γ-butyrolactone, gamma-butyrolactone methacrylate-α or -β (GBLMA; either α- or β-), methacryloyloxy norbornane methacrylate (MNBL), and α-methacryloxy-γ-butyrolactone, among others. Examples of polymers formed with these monomers include poly(2-methyl-2-adamantyl methacrylate-co-2-ethyl-2-adamantyl methacrylate-co-3-hydroxy-1-methacryloxyadamantane-co-α-gamma-butyrolactone methacrylate); poly(2-ethyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-β-gamma-butyrolactone methacrylate); poly(t-butyl norbornene carboxylate-co-maleic anhydride-co-2-methyl-2-adamantyl methacrylate-co-β-gamma-butyrolactone methacrylate-co-methacryloyloxy norbornane methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-β-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); poly(2-methyl-2-adamantyl methacrylate-co-3,5-dihydroxy-1-methacryloxyadamantane-co-α-gamma-butyrolactone methacrylate); poly(2-methyl-2-adamantyl methacrylate-co-3,5-dimethyl-7-hydroxy adamantyl methacrylate-co-α-gamma-butyrolactone methacrylate); poly(2-methyl-2-adamantyl acrylate-co-3-hydroxy-1-methacryloxyadamantane-co-α-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-β-gamma-butyrolactone methacrylate-co-3-hydroxy-1-methacryloxyadamantane-co-ethylcyclopentylacrylate); poly(2-methyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-methacryloxyadamantane-co-α-gamma-butyrolactone methacrylate-co-2-ethyl-2-adamantyl methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-2-ethyl-2-adamantyl methacrylate-co-β-gamma-butyrolactone methacrylate-co-3-hydroxy-1-methacryloxyadamantane); poly(2-methyl-2-adamantyl methacrylate-co-2-ethyl-2-adamantyl methacrylate-co-α-gamma-butyrolactone methacrylate-co-3-hydroxy-1-methacryloxyadamantane).

Other examples of suitable polymers include those described in U.S. Pat. Nos. 6,610,465, 6,120,977, 6,136,504, 6,013,416, 5,985,522, 5,843,624, 5,693,453, 4,491,628, WO 00/25178, WO 00/67072, JP 2000-275845, JP 2000-137327, and JP 09-73173 which are incorporated herein by reference. Blends of one or more photoresist resins may be used. Standard synthetic methods are typically employed to make the various types of suitable polymers. Procedures or references to suitable standard procedures (e.g., free radical polymerization) can be found in the aforementioned documents.

The cycloolefin and the cyclic anhydride monomer are believed to form an alternating polymeric structure, and the amount of the (meth)acrylate monomer incorporated into the polymer can be varied to give the optimal lithographic properties. The percentage of the (meth)acrylate monomer relative to the cycloolefin/anhydride monomers within the polymer ranges from about 95 mole % to about 5 mole %, further ranging from about 75 mole % to about 25 mole %, and also further ranging from about 55 mole % to about 45 mole %.

Fluorinated non-phenolic polymers, useful for 157 nm exposure, also exhibit line edge roughness and can benefit from the use of the novel mixture of photoactive compounds described in the present invention. Such polymers are described in WO 00/17712 and WO 00/67072 and incorporated herein by reference. Example of one such polymer is poly(tetrafluoroethylene-co-norbornene-co-5-hexafluoroisopropanol-substituted 2-norbornene.

Polymers synthesized from cycloolefins and cyano containing ethylenic monomers are described in the U.S. Pat. No. 6,686,429, the contents of which are hereby incorporated herein by reference, may also be used.

The molecular weight of the polymers is optimized based on the type of chemistry used and on the lithographic performance desired. Typically, the weight average molecular weight is in the range of 3,000 to 30,000 and the polydispersity is in the range 1.1 to 5, preferably 1.5 to 2.5.

Other polymers of interest include those found and described in U.S. patent application Ser. No. 10/371,262, filed Feb. 21, 2003, the contents of which are incorporated herein by reference. Still other polymers, such as those disclosed in U.S. patent application Ser. No. 10/440,452, filed May 16, 2003 titled “Photoresist Composition for Deep UV and Process Thereof”, the contents of which are hereby incorporated herein by reference, may also be used.

The solid components of the present invention are dissolved in an organic solvent. The amount of solids in the solvent or mixture of solvents ranges from about 1 weight % to about 50 weight %. The polymer may be in the range of 5 weight % to 90 weight % of the solids and the photoacid generator may be in the range of 1 weight % to about 50 weight % of the solids. Suitable solvents for such photoresists may include a glycol ether derivative such as ethyl cellosolve, methyl cellosolve, propylene glycol monomethyl ether, diethylene glycol monomethyl ether, diethylene glycol monoethyl ether, dipropylene glycol dimethyl ether, propylene glycol n-propyl ether, or diethylene glycol dimethyl ether; a glycol ether ester derivative such as ethyl cellosolve acetate, methyl cellosolve acetate, or propylene glycol monomethyl ether acetate; carboxylates such as ethyl acetate, n-butyl acetate and amyl acetate; carboxylates of di-basic acids such as diethyloxylate and diethylmalonate; dicarboxylates of glycols such as ethylene glycol diacetate and propylene glycol diacetate; and hydroxy carboxylates such as methyl lactate, ethyl lactate, ethyl glycolate, and ethyl-3-hydroxy propionate; a ketone ester such as methylpyruvate or ethyl pyruvate; an alkoxycarboxylic acid ester such as methyl 3-methoxypropionate, ethyl 3-ethoxypropionate, ethyl 2-hydroxy-2-methylpropionate, or methylethoxypropionate; a ketone derivative such as methyl ethyl ketone, acetyl acetone, cyclopentanone, cyclohexanone or 2-heptanone; a ketone ether derivative such as diacetone alcohol methyl ether; a ketone alcohol derivative such as acetol or diacetone alcohol; lactones such as butyrolactone; an amide derivative such as dimethylacetamide or dimethylformamide, anisole, and mixtures thereof.

Various other additives such as colorants, non-actinic dyes, anti-striation agents, plasticizers, adhesion promoters, dissolution inhibitors, coating aids, photospeed enhancers, additional photoacid generators, and solubility enhancers (for example, certain small levels of solvents not used as part of the main solvent (examples of which include glycol ethers and glycol ether acetates, valerolactone, ketones, lactones, and the like), and surfactants may be added to the photoresist composition before the solution is coated onto a substrate. Surfactants that improve film thickness uniformity, such as fluorinated surfactants, can be added to the photoresist solution. A sensitizer that transfers energy from a particular range of wavelengths to a different exposure wavelength may also be added to the photoresist composition. Often bases are also added to the photoresist to prevent t-tops or bridging at the surface of the photoresist image. Examples of bases are amines, ammonium hydroxide, and photosensitive bases. Particularly preferred bases are trioctylamine, diethanolamine and tetrabutylammonium hydroxide.

The prepared photoresist composition solution can be applied to a substrate by any conventional method used in the photoresist art, including dipping, spraying, and spin coating. When spin coating, for example, the photoresist solution can be adjusted with respect to the percentage of solids content, in order to provide coating of the desired thickness, given the type of spinning equipment utilized and the amount of time allowed for the spinning process. Suitable substrates include silicon, aluminum, polymeric resins, silicon dioxide, doped silicon dioxide, silicon nitride, tantalum, copper, polysilicon, ceramics, aluminum/copper mixtures; gallium arsenide and other such Group III/V compounds. The photoresist may also be coated over antireflective coatings.

The photoresist coatings produced by the described procedure are particularly suitable for application to silicon/silicon dioxide wafers, such as are utilized in the production of microprocessors and other miniaturized integrated circuit components. An aluminum/aluminum oxide wafer can also be used. The substrate may also comprise various polymeric resins, especially transparent polymers such as polyesters.

The photoresist composition solution is then coated onto the substrate, and the substrate is treated (baked) at a temperature from about 70° C. to about 150° C. for from about 30 seconds to about 180 seconds on a hot plate or for from about 15 to about 90 minutes in a convection oven. This temperature treatment is selected in order to reduce the concentration of residual solvents in the photoresist, while not causing substantial thermal degradation of the solid components. In general, one desires to minimize the concentration of solvents and this first temperature. Treatment (baking) is conducted until substantially all of the solvents have evaporated and a thin coating of photoresist composition, on the order of half a micron (micrometer) in thickness, remains on the substrate. In a preferred embodiment the temperature is from about 95° C. to about 120° C. The treatment is conducted until the rate of change of solvent removal becomes relatively insignificant. The film thickness, temperature and time selection depends on the photoresist properties desired by the user, as well as the equipment used and commercially desired coating times. The coated substrate can then be imagewise exposed to actinic radiation, e.g., ultraviolet radiation, at a wavelength of from about 100 nm (nanometers) to about 300 nm, x-ray, electron beam, ion beam or laser radiation, in any desired pattern, produced by use of suitable masks, negatives, stencils, templates, etc.

The photoresist is then subjected to a post exposure second baking or heat treatment before development. The heating temperatures may range from about 90° C. to about 150° C., more preferably from about 100° C. to about 130° C. The heating may be conducted for from about 30 seconds to about 2 minutes, more preferably from about 60 seconds to about 90 seconds on a hot plate or about 30 to about 45 minutes by convection oven.

The exposed photoresist-coated substrates are developed to remove the image-wise exposed areas by immersion in a developing solution or developed by spray development process. The solution is preferably agitated, for example, by nitrogen burst agitation. The substrates are allowed to remain in the developer until all, or substantially all, of the photoresist coating has dissolved from the exposed areas. Developers include aqueous solutions of ammonium or alkali metal hydroxides. One preferred developer is an aqueous solution of tetramethyl ammonium hydroxide. After removal of the coated wafers from the developing solution, one may conduct an optional post-development heat treatment or bake to increase the coating's adhesion and chemical resistance to etching conditions and other substances. The post-development heat treatment can comprise the oven baking of the coating and substrate below the coating's softening point or UV hardening process. In industrial applications, particularly in the manufacture of microcircuitry units on silicon/silicon dioxide-type substrates, the developed substrates may be treated with a buffered, hydrofluoric acid base etching solution or dry etching. Prior to dry etching the photoresist may be treated to electron beam curing in order to increase the dry-etch resistance of the photoresist.

The invention further provides a method for producing a semiconductor device by producing a photo-image on a substrate by coating a suitable substrate with a photoresist composition. The subject process comprises coating a suitable substrate with a photoresist composition and heat treating the coated substrate until substantially all of the photoresist solvent is removed; image-wise exposing the composition and removing the image-wise exposed areas of such composition with a suitable developer.

The following examples provide illustrations of the methods of producing and utilizing the present invention. These examples are not intended, however, to limit or restrict the scope of the invention in any way and should not be construed as providing conditions, parameters or values which must be utilized exclusively in order to practice the present invention. Unless otherwise specified, all parts and percents are by weight.

### EXAMPLE 1

### Synthesis of 3,5-dimethyl-4-hydroxyphenyldimethyl sulfonium tetrafluoroethoxy octafluorobutane sulfonate

3,5-dimethyl-4-hydroxyphenyldimethyl sulfonium chloride (5 g, 0.0229 mole) was dissolved in 150 ml water in a suitable vessel. Lithium tetrafluoroethoxy octafluorobutane sulfonate (17.12 g at 54.4% solid in water) was added with stirring at room temperature. The mixture was stirred for two hours and extracted with chloroform. The organic phase was washed with deionized water (4×200 ml) and the organic (chloroform) layer was dried over anhydrous sodium sulfate and filtered. The chloroform was evaporated using a vacuum evaporator and a colored oil remained. The colored oil was washed several times with hexane. Yield, 40% oil. ¹H NMR (Acetone d₆): 2.35 (s, 6H, 2CH₃), 3.4 (s, 6H, 2CH₃), 6.9-7.25,1H, 7.80 (s, 2H, aromatic).

### EXAMPLE 1A

### Alternate Synthesis of 3,5-dimethyl-4-hydroxyphenyldimethyl sulfonium tetrafluoroethoxy octafluorobutane sulfonate

3,5-dimethyl-4-hydroxyphenyldimethyl sulfonium chloride (50 g, 0.23 mole) was dissolved in 450 ml water, lithium tetrafluoroethoxy octafluorobutane sulfonate (200.2 g at 46.4% solid in water) was added with stirring at room temperature. The mixture was stirred for two hours and extracted with chloroform (900 ml). Chloroform was evaporated under vacuum and hexane was added and the mixture was stirred for 30 minutes. The hexane layer was removed and ether (700 ml) was added. A precipitate formed and the mixture was filtered with the precipitate being retained. The precipitate was added to methylene chloride and reprecipitated from ether and filtered. The remaining solid was dried in a vacuum oven at less than 40° C. The resulting crystals had a melting point of 71° C. ¹H NMR (Acetone-d₆), 2.35 (s, 6H, 2×CH₃), 3.4 (s, 6H, 2CH₃); 6.9-7.25, 1H, 7.80 (s, 2H, aromatic).

### EXAMPLE 2

### Synthesis of 3,5-dimethyl-4-hydroxyphenyldimethyl sulfonium trifluoroethoxy octafluorobutane sulfonate

In a similar manner to that of Example 1, 2.185 g (0.01 mole) of 3,5-dimethyl-4-hydroxyphenyldimethyl sulfonium chloride was reacted with lithium trifluoroethoxy octafluorobutane sulfonate (3.86 g at 7.72% solid in water). An oil was extracted as in Example 1. Yield, 65% oil.

### EXAMPLE 3

### Synthesis of 3,5-dimethyl-4-acetoxyphenyldimethyl sulfonium trifluoroethoxy octafluorobutane sulfonate

An aliquot of the compound formed in Example 1 was reacted with acetic anhydride in the presence of potassium carbonate in acetone. The mixture was worked up and extractions were done in a similar manner to that of Example 1. An oil was obtained.

### EXAMPLE 4

### Synthesis of 4-methoxyphenyldimethyl sulfonium tetrafluoroethoxy octafluorobutane sulfonate

4-methoxyphenyldimethyl sulfonium chloride (6.36 g) was dissolved in 70 ml ethyl acetate in a suitable vessel. Lithium tetrafluoroethoxy octafluorobutane sulfonate (30 g at 54.4% solid in water) was added with stirring at room temperature and then 70 ml of water were added and the mixture was stirred overnight. The mixture was then extracted with chloroform. The organic phase was washed with deionized water (4×200 ml) and the organic (chloroform) layer was dried over anhydrous sodium sulfate and filtered. The chloroform was evaporated using a vacuum evaporator and a colored oil remained. The colored oil was washed several times with hexane. Yield, 60% viscous oil. ¹H NMR (Acetone d₆): 3.47 (s, 6H, 2CH₃), 4.0 (s, 3H, OCH₃), 6.9-7.25, 1H, 7.30 (d, 2H, aromatic), 8.15 (d, 2H, aromatic).

### EXAMPLE 5

A photoresist solution was prepared by mixing 20 μmol/g of the compound of Example 2 together with a polymer based on 2-methyl-2-adamantyl methacrylate, 2-ethyl-2-adamantyl methacrylate, gamma-butyrolactone methacrylate, and 3-hydroxy-1-methacryloxyadamantane; FC-4430 fluorosurfactant (from 3M); base; triphenylsulfonium nonaflate; and solvent (PGMEA/PGME). The photoresist solution was filtered through 0.2 μm filter.

### EXAMPLE 6

A silicon substrate coated with a bottom antireflective coating (B.A.R.C.) was prepared by spin coating the B.A.R.C. solution (AZ® EXP ArF-1 B.A.R.C. available from Clariant Corporation, Somerville, N.J.) onto the silicon substrate and baked at 175° C. for 60 sec. The B.A.R.C film thickness was 37 nm. The photoresist solution from Example 5 was then coated on the B.A.R.C coated silicon substrate. The spin speed was adjusted such that the photoresist film thickness was 150 nm. The photoresist film was baked at 140° C. for 60 sec. The substrate was then exposed in a Nikon 306C, 0.78NA & Dipole X illumination. After exposure, the wafer was baked at 130° C. for 60 sec (development time 60 s (ACT12), 6% PSM). The imaged photoresist was then developed using a 2.38 weight % aqueous solution of tetramethyl ammonium hydroxide for 30 sec. The line and space patterns were then observed on a scanning electron microscope. The photoresist had a photosensitivity of 41.5 mJ/cm² and good DOF.

### EXAMPLE 7

Additional photoresist solutions were prepared in accordance with Example 5, using other 2-methyl-2-adamantyl methacrylate based copolymers. These solutions were evaluated in accordance with the procedure in Example 6. The resulting photoresists had photosensitivities ranging from 23 to 38 mJ/cm² and good DOF.

### EXAMPLE 8

Additional photoresist solutions can be were prepared in accordance with Example 5, using the compound from Example 4 and other 2-methyl-2-adamantyl methacrylate based copolymers. These solutions can be evaluated in accordance with the procedure in Example 6. The resulting photoresists are expected to have photosensitivities ranging from about 20 to 40 mJ/cm² and good DOF.

1. A compound having the formula 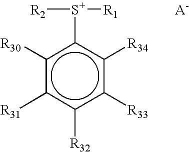
wherein R₁ and R₂ are each independently selected from C₁₋₂₀ straight or branched alkyl chain; each of R₃₀, R₃₁, R₃₂, R₃₃, and R₃₄ are independently selected from Z, hydrogen, C₁₋₂₀ straight or branched alkyl chain optionally containing one or more O atoms, C₅₋₅₀ monocyclic or polycyclic alkyl group, C₅₋₅₀ cyclic alkylcarbonyl group, C₆₋₅₀ aryl group, C₆₋₅₀ aralkyl group, arylcarbonylmethylene group, —OR₄ where R₄ is hydrogen, C₁₋₂₀ straight or branched alkyl group or C₅₋₅₀ monocyclic or polycyclic alkyl group; Z is —(O)ₖ—(V)ₙ—Y, where V is a linkage group selected from a divalent C₁₋₂₀ straight or branched alkyl group, divalent C₅₋₅₀ aryl group, divalent C₅₋₅₀ aralkyl group, or divalent C₅₋₅₀ monocyclic or polycyclic alkyl group; Y is selected from —C(═O)O—R₈ and —O—C(═O)—R₈; R₈ is a C₁₋₂₀ straight or branched alkyl chain optionally containing one or more O atoms, a C₅₋₅₀ monocyclic or polycyclic alkyl group, or a C₅₋₅₀ aryl group; k is 0 or 1, and n is 0 or 1; the C₁₋₂₀ straight or branched alkyl chain optionally containing one or more O atoms, C₁₋₂₀ straight or branched alkyl chain, C₅₋₅₀ monocyclic or polycyclic alkyl group, C₅₋₅₀ cyclic alkylcarbonyl group, C₅₋₅₀ aralkyl group, C₅₋₅₀ aryl group, or arylcarbonylmethylene group being unsubstituted or substituted by one or more groups selected from the group consisting of Z, halogen, C₁₋₂₀ alkyl, C₁₋₂₀ perfluoroalkyl C₃₋₂₀ cyclic alkyl, C₁₋₂₀ alkoxy, C₃₋₂₀ cyclic alkoxy, di C₁₋₂₀ alkylamino, dicyclic di C₁₋₂₀ alkylamino, hydroxyl, cyano, nitro, tresyl, oxo, aryl, aralkyl, oxygen atom, CF₃SO₃, aryloxy, arylthio, and groups of formulae (II) to (VI): 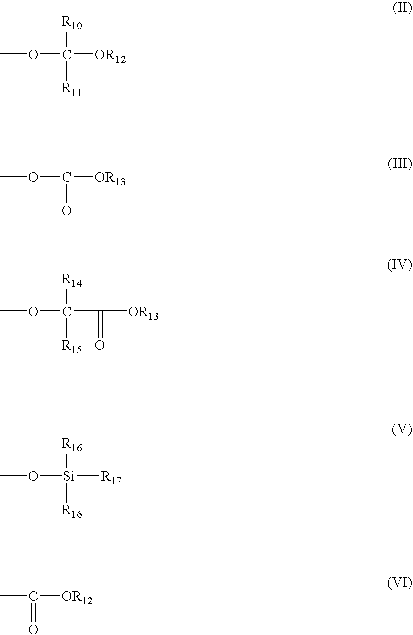
R₁₀ and R₁₁ each independently represent a hydrogen atom, a C₁₋₂₀ straight or branched alkyl chain optionally containing one or more O atoms, or a C₅₋₅₀ monocyclic or polycyclic alkyl group, or R₁₀ and R₁₁ together can represent an alkylene group to form a five- or six-membered ring,
R₁₂ represents a C₁₋₂₀ straight or branched alkyl chain optionally containing one or more O atoms, a C₅₋₅₀ monocyclic or polycyclic alkyl group, or a C₅₋₅₀ aralkyl group, or R₁₀ and R₁₂ together represent an alkylene group which forms a five- or six-membered ring together with the interposing —C—O— group, the carbon atom in the ring being optionally substituted by an oxygen atom,
R₁₃ represents a C₁₋₂₀ straight or branched alkyl chain optionally containing one or more O atoms or a C₅₋₅₀ monocyclic or polycyclic alkyl group,
R₁₄ and R₁₅ each independently represent a hydrogen atom, a C₁₋₂₀ straight or branched alkyl chain optionally containing one or more O atoms or a C₅₋₅₀ monocyclic or polycyclic alkyl group,
R₁₆ represents a C₁₋₂₀ straight or branched alkyl chain optionally containing one or more O atoms, a C₅₋₅₀ monocyclic or polycyclic alkyl group, a C₅₋₅₀ aryl group, or a C₅₋₅₀ aralkyl group, and
R₁₇ represents C₁₋₂₀ straight or branched alkyl chain optionally containing one or more O atoms, a C₅₋₅₀ monocyclic or polycyclic alkyl group, a C₅₋₅₀ aryl group, a C₅₋₅₀ aralkyl group, the group —Si(R₁₆)₂R₁₇, or the group —O—Si(R₁₆)₂R₁₇, the C₁₋₂₀ straight or branched alkyl chain optionally containing one or more O atoms, C₅₋₅₀ monocyclic, bicyclic, or tricyclic alkyl group, C₅₋₅₀ aryl group, and C₅₋₅₀ aralkyl group being unsubstituted or substituted as above; and
A⁻ is an anion represented by the formula
Rg-O-Rf-SO₃⁻
where Rf is selected from the group consisting of linear or branched (CF₂)ⱼ where j is an integer from 4 to 10 and C₃-C₁₂ perfluorocycloalkyl divalent radical which is optionally perfluoroC₁₋₁₀alkyl substituted,
Rg is selected from the group consisting of C₁-C₂₀ linear, branched, monocyclic or polycyclic alkyl, C₁-C₂₀ linear, branched, monocyclic or polycyclic alkenyl, C₅₋₅₀ aryl, and C₅₋₅₀ aralkyl, the alkyl, alkenyl, aralkyl and aryl groups being unsubstituted, substituted, partially fluorinated or perfluorinated.

2. The compound of claim 1 wherein R₃₀ and R₃₄ are hydrogen.

3. The compound of claim 2 wherein R₁ and R₂ are each independently selected from C₁₋₂₀ straight or branched alkyl chain and each of R₃₁, R₃₂, and R₃₃ are independently selected from hydrogen, Z, —OR₄, and C₁₋₂₀ straight or branched alkyl chain optionally containing one or more O atoms.

4. The compound of claim 3 wherein each of R₃₁ and R₃₃ are C₁₋₂₀ straight or branched alkyl chain optionally containing one or more O atoms.

5. The compound of claim 3 wherein R₃₂ is selected from —OR₄ and Z.

6. The compound of claim 5 wherein R₃₂ is —OR₄.

7. The compound of claim 6 wherein R₄ is C₁₋₂₀ straight or branched alkyl group.

8. The compound of claim 6 wherein R₄ is hydrogen.

9. The compound of claim 6 wherein R₄ is C₅₋₅₀ monocyclic or polycyclic alkyl group.

10. The compound of claim 3 wherein each of R₃₁ and R₃₃ are hydrogen.

11. The compound of claim 10 wherein R₃₂ is —OR₄.

12. The compound of claim 11 wherein R₄ is C₁₋₂₀ straight or branched alkyl group.

13. The compound of claim 6 wherein R₃₂ is Z.

14. The compound of claim 13 wherein k is 0, n is 0 and Y is —O—C(═O)R₈.

15. The compound of claim 14 wherein R₈ is C₁₋₂₀ straight or branched alkyl chain optionally containing one or more O atoms.

16. The compound of claim 13 wherein k is 1, n is 1, V is a divalent C₁₋₂₀ straight or branched alkyl group and Y is C(═O—R₈.

17. The compound of claim 16 wherein R₈ is C₁₋₂₀ straight or branched alkyl chain optionally containing one or more O atoms.

18. The compound of claim 1, wherein A⁻ is selected from CF₃CHFO(CF₂)₄SO₃⁻, CF₃CH₂O(CF₂)₄SO₃⁻, CH₃CH₂O(CF₂)₄SO₃⁻, and CH₃CH₂CH₂O(CF₂)₄SO₃⁻.

19. The compound of claim 1,

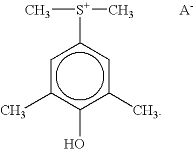

20. The compound of claim 19 selected from the group consisting of

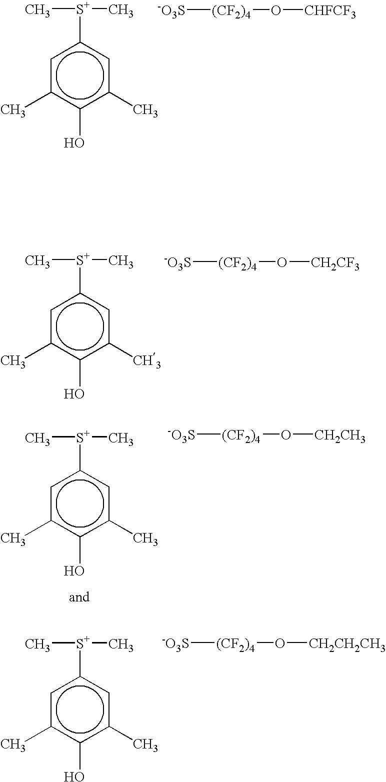

21. The compound of claim 1,

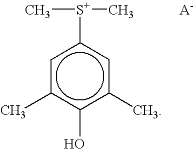

22. The compound of claim 21 selected from the group consisting of

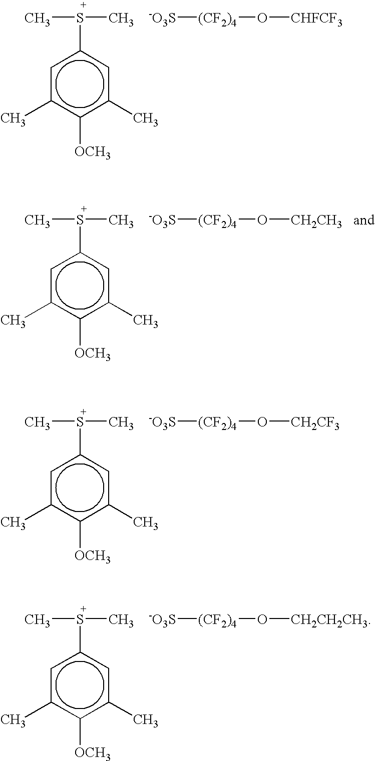

23. The compound of claim 1,

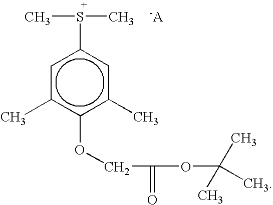

24. The compound of claim 23 selected from the group consisting of

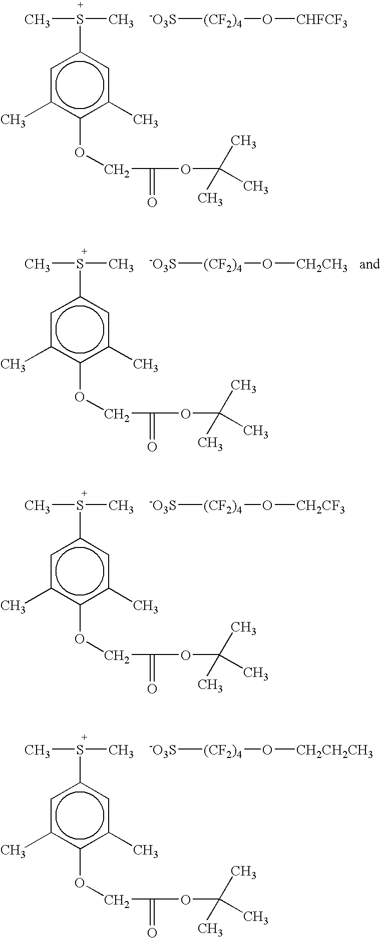

25. The compound of claim 1

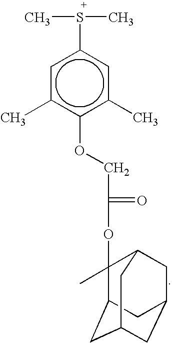

26. The compound of claim 25 selected from the group consisting of

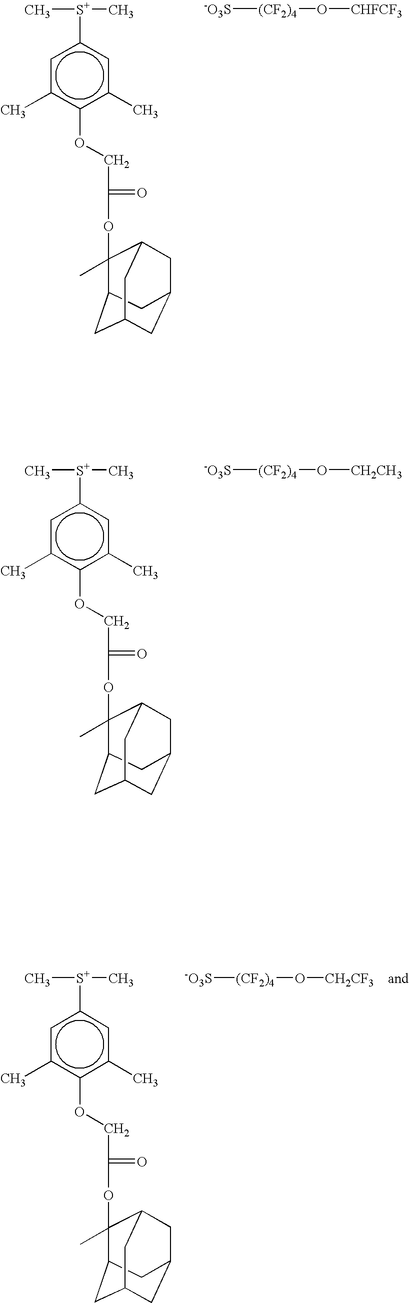

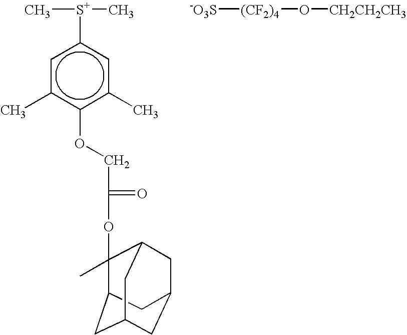

27. The compound of claim 1,

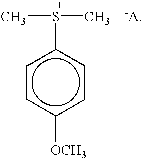

28. The compound of claim 27 selected from the group consisting of

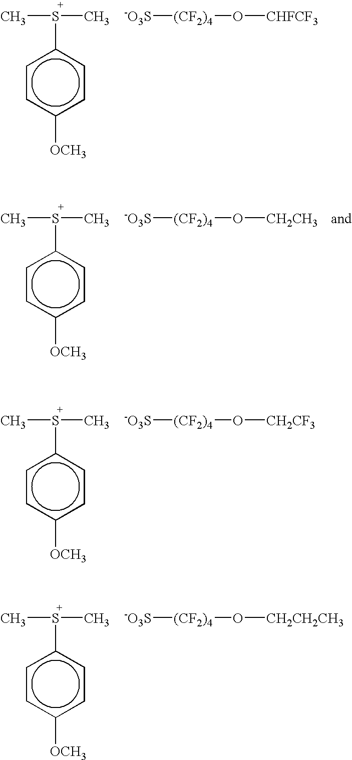

29. A photoresist composition useful for imaging in deep UV comprising;
a) a polymer containing an acid labile group; and,
b) a compound of claim 1.

30. The photoresist composition of claim 29 wherein a) the polymer comprises one or more monomers selected from maleic anhydride, t-butyl norbornene carboxylate, mevalonic lactone methacrylate, 2-methyl-2-adamantyl methacrylate, 2-methyl-2-adamantyl acrylate, 2-ethyl-2-adamantyl methacrylate, 3,5-dimethyl-7-hydroxy adamantyl methacrylate, 3-hydroxy-1-methacryloxyadamantane, 3-hydroxy-1-adamantyl acrylate, ethycyclopentylacrylate, tricyclo[5,2, 1,0^{2,6}]deca-8-yl methacrylate, 3,5-dihydroxy-1-methacryloxyadamantane, gamma-butyrolactone methacrylate, methacryloylxy norbornane methacrylate, and mixtures thereof.

31. The photoresist composition of claim 29 wherein a) the polymer is selected from the group poly(2-methyl-2-adamantyl methacrylate-co-2-ethyl-2-adamantyl methacrylate-co-3-hydroxy-1-methacryloxyadamantane-co-α-gamma-butyrolactone methacrylate); poly(2-ethyl-2-adamantyl methacrylate-co-3-hydroxy-1-methacryloxyadamantane-co-β-gamma-butyrolactone methacrylate); poly(2-methyl-2-adamantyl methacrylate-co-3-hydroxy-1-methacryloxyadamantane-co-α-gamma-butyrolactone methacrylate); poly(t-butyl norbornene carboxylate-co-maleic anhydride-co-2-methyl-2-adamantyl methacrylate-co-β-gamma-butyrolactone methacrylate-co-methacryloyloxy norbornane methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-β-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); poly(2-methyl-2-adamantyl methacrylate-co-3,5-dihydroxy-1-methacryloxyadamantane-co-α-gamma-butyrolactone methacrylate); poly(2-methyl-2-adamantyl methacrylate-co-3,5-dimethyl-7-hydroxy adamantyl methacrylate-co-α-gamma-butyrolactone methacrylate); poly(2-methyl-2-adamantyl acrylate-co-3-hydroxy-1-methacryloxyadamantane-co-α-gamma-butyrolactone methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-β-gamma-butyrolactone methacrylate-co-3-hydroxy-1-methacryloxyadamantane-co-ethylcyclopentylacrylate); poly(2-methyl-2-adamantyl methacrylate-co-3-hydroxy-1-adamantyl acrylate-co-α-gamma-butyrolactone methacrylate); poly(2-methyl-2-adamantyl methacrylate-co-3-hydroxy-1-methacryloxyadamantane-co-α-gamma-butyrolactone methacrylate-co-2-ethyl-2-adamantyl methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-methyl-2-adamantyl methacrylate-co-2-ethyl-2-adamantyl methacrylate-co-β-gamma-butyrolactone methacrylate-co-3-hydroxy-1-methacryloxyadamantane); and poly(2-methyl-2-adamantyl methacrylate-co-2-ethyl-2-adamantyl methacrylate-co-α-gamma-butyrolactone methacrylate-co-3-hydroxy-1-methacryloxyadamantane).

32. The photoresist composition of claim 29 wherein a) the polymer is selected from poly(2-methyl-2-adamantyl methacrylate-co-2-ethyl-2-adamantyl methacrylate-co-3-hydroxy-1-methacryloxyadamantane-co-α-gamma-butyrolactone methacrylate); poly(2-ethyl-2-adamantyl methacrylate-co-3-hydroxy-1-methacryloxyadamantane-co-β-gamma-butyrolactone methacrylate); poly(t-butyl norbornene carboxylate-co-maleic anhydride-co-2-methyl-2-adamantyl methacrylate-co-β-gamma-butyrolactone methacrylate-co-methacryloyloxy norbornane methacrylate); poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate); poly(2-ethyl-2-adamantyl methacrylate-co-3-hydroxy-1-adamantyl acrylate-co-β-gamma-butyrolactone methacrylate); poly(2-ethyl-2-adamantyl methacrylate-co-3-hydroxy-1-adamantyl acrylate-co-α-gamma-butyrolactone methacrylate-co-tricyclo[5,2,1,0^{2,6}]deca-8-yl methacrylate); and poly(2-methyl-2-adamantyl methacrylate-co-3-hydroxy-1-methacryloxyadamantane-co-β-gamma-butyrolactone methacrylate-co-tricyclo[5,2,1,0^{2,6}]deca-8-yl methacrylate).

33. A process for imaging a photoresist comprising the steps of:
a) coating a substrate with the composition of claim 29;
b) baking the substrate to substantially remove the solvent;
c) image-wise exposing the photoresist coating;
d) post-exposure baking the photoresist coating; and
e) developing the photoresist coating with an aqueous alkaline solution.

34. The process of claim 33, where the image-wise exposure wavelength is below 200 nm.

35. The process according to claim 33, where the aqueous alkaline solution comprises tetramethylammonium hydroxide.

36. The process according to claim 33, where the aqueous alkaline solution further comprises a surfactant.

37. The process according to claim 33, where the substrate is selected from a microelectronic device and a liquid crystal display substrate.

38. A method for producing a semiconductor device by producing a photo-image on a substrate by coating a suitable substrate with a photoresist composition comprising:
a) coating a suitable substrate with the composition of claim 29;
b) heat treating the coated substrate of step a) until substantially all of the photoresist solvent is removed; image-wise exposing the composition and removing the image-wise exposed areas of such composition with a suitable developer.
